(19) United States
(12) Patent Application Publication
(10) Pub. No.: US 2020/0175028 A1
(43) Pub. Date: Jun. 4, 2020

(54) SYSTEM AND METHOD FOR INGESTING DATA

(71) Applicant: Owned Outcomes Inc., Las Vegas, NV (US)

(72) Inventors: Wojciech Sebastian Kozlowski, Bialystok (PL); Rohan Kumar Sudhir Vardhan, Las Vegas, NV (US); Chandan Kumar Singh, Las Vegas, NV (US); Rathna Shan Reddy, Las Vegas, NV (US); Dharini Govindarajan, Las Vegas, NV (US); Anita Pramoda, Las Vegas, NV (US)

(21) Appl. No.: 16/209,606

(22) Filed: Dec. 4, 2018

(51) Int. Cl. G06F 16/25; G06F 17/27; G06F 16/9538; G06F 16/951; G06F 16/958

(52) U.S. Cl. CPC G06F 16/254; G06F 17/2705; G06F 16/958; G06F 16/951; G06F 16/9538

(57) ABSTRACT

The present disclosure includes systems and a methods for ingestion and processing of data in large volumes and varied data models. The system consists of a data intake adapter, tagging service, relation service, query service, persistence service and physical storage medium. The data intake adapters are implemented to support required data formats and models. The invention includes a method enabling assignments of tags to any data element that can be referenced in the system, including in some embodiments tables, rows, columns, data points, nodes, vectors, lists or other types. The invention further includes a method of data representation for tags data using hash tree data structures. The disclosure also includes a relations mechanism and service that is capable of defining relations between data elements. The disclosed system includes also a query service that leverages the internal data structures to provide efficient lookup and retrieval methods supporting vast range of analytical use cases. The disclosure also describes a method of iterative processing using new data delivered to the system to increase data quality, and a method for working with user feedback to improve searching capabilities.

### TECHNICAL FIELD

The present disclosure relates to the fields of computerized systems, software development, analytics, and data processing. More specifically, the present disclosure relates to a data ingestion platform that is capable of processing a variety of data types and can be applied to a wide variety of data domains in which the storing and retrieval heterogeneous data is needed, particularly healthcare and life science data.

### BACKGROUND

Big data is a term that refers to very large data sets and such data sets are becoming exponentially more pervasive and sizable. The volume, variety, and velocity of data is creating challenges for contemporary systems. Big data analysis remains in high demand worldwide. Companies that can effectively employ and analyze big data have the power to understand large-scale market trends, consumer preferences, and demographic correlations. However, in order to properly analyze and process big data, it is necessary to create a platform that can produce data models and relations out of a variety of data.

Moreover, machine learning and artificial intelligence methods rely on large data sets and in many cases require intensive data processing in order to analyze and model the data. Depending on the desired method, the processing can include labeling data to assign information to data elements (also known as annotating or tagging). The methods of adding labels are often based on human input, for example using services such as AMAZON MECHANICAL TURK or APPEN. Furthermore, the process of organizing and enhancing data is often domain specific (e.g. medical imaging analysis). The annotations are usually generated based on limited scope of information (i.e. single data element) and do not include context and relations to other information. Contemporary systems require additional components to support querying and analyzes of annotations. Tagging is used in some systems in healthcare or life sciences field and can use a markup language to represent the tagged data internally, which may not be suitable for working with big data because such data structures are not optimized for lookup of large volumes of data.

Currently, the data storage and processing market is primarily dominated by relational databases and NoSQL databases. Relational database systems are ubiquitously used for data storage, querying, and retrieval. However, relational databases can require the upfront development of particular schemas and significant modeling efforts. Moreover, the data structures of relational databases are limited when compared to the technologies used in modern high level languages.

NoSQL systems provide data storage in a flexible manner with horizontal scalability. Because NoSQL databases do not require schema declaration, they can support fast development cycles and are better suited for agile projects. NoSQL databases enable developers to use data structures and models without the need to convert them to relational models.

These traditional approaches to working with database systems assume separate processes for loading data and for understanding the obtained information. Very often, data ingestion and processing require different tools and skills. The ingestion and processing of data are also frequently separated in time, because the design of relational schemas and data modeling have to be completed before progressing with other project tasks. These shortfalls can significantly limit the ability to quickly deliver insights and make use of the gathered data.

### SUMMARY OF THE INVENTION

Embodiments of the invention include systems and methods capable of ingesting different data formats without the need to build models or transform the data. The introduction of tagging and relations mechanisms as part of the data processing also aids to overcome the shortfalls of conventional systems. Tagging and relations mechanisms allow the data to be available for searching and analysis immediately after loading, avoiding the need to build business views that organize the data in ways accessible for an end user. The system is capable of ingesting and processing data from a variety of database models. Examples of such models include hierarchical, relational, network, object-oriented, entity relationship, document, entity-attribute-value, start schema, etc. The ingested data can then be accessed by a different data model. For instance, the system allows the ingested data to be accessed with a user-created data model that is optimized to interact with the data in the system. Embodiments may include components that have the ability to ingest different data formats without the need to build models or transform data. Other embodiments may introduce tagging and relations mechanisms as part of the data processing, which make data from the ingested data available for searching and analyses almost immediately after loading. This may avoid the need to build business views that organize the data in ways accessible for end users.

The techniques disclosed herein have several features, no single one of which is solely responsible for its desirable attributes. Without limiting the scope as expressed by the claims that follow, certain features of the present disclosure will now be discussed briefly. One skilled in the art will understand how the features provide several advantages over traditional systems and methods.

The present disclosure relates to embodiments of a data ingestion and processing platform that is capable of supporting a large number of different data types. The system can be applied in the fields of healthcare and life sciences, as well as a wide variety of domains in which the storing and retrieval heterogeneous data is needed. The system is capable of accepting data that has been stored in any structure or model and processes the data elements themselves through ingestion and subsequent tagging. The data elements may be stored in individual memory addresses from which they can be accessed by any number of models or programming languages, irrespective of the source of the data elements. A tagging mechanism is configured to annotate specific data points individually, regardless of the structure or model in which the data is provided to the system. After the data is tagged, the system can further include a relations mechanism to enhance the data with information about relations between the tagged data elements. By enhancing the tagged data with relational information, the system can ease querying and analysis demands on later search queries designed to discover specific data within the data set. In some embodiments, the system further includes a query service that enables users to access data and supports effective lookup and retrieval capabilities by leveraging the internal data representation of the tagged data.

One embodiment includes an electronic system for ingesting and processing data from multiple sources, the system including a data ingestion service configured to parse the data into data elements and to ingest each data element as an independent transaction; a tagging service configured to assign information to each data element; a relations service configured to identify relations between the data elements; a query service configured to receive a query request, and in response, access, lookup, and retrieve data that matches the request; and a physical storage component configured to store the data elements and tagging information, wherein each data element is assigned to a memory address in the physical storage component and is hashed to obtain a unique string representation for each data element, the string representation being mapped to the memory address.

Another embodiment includes an electronic method running on a processor for ingesting and processing data from multiple sources. This method may include loading the data for discovery, ingestion, and processing; and parsing the data into data elements, each data element being ingested as an independent transaction, wherein each data element is assigned to a memory address in the physical storage component and is hashed to obtain a unique string representation for each data element, the string representation being mapped to the memory address.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 illustrates a schematic diagram of a system for data ingestion and processing.

FIG. 2 illustrates data being stored and represented in the system of FIG. 1, according to one embodiment.

FIG. 3 illustrates example relations that can be derived using a relations service of FIG. 1, according to one embodiment.

FIG. 4 illustrates a wireframe of an example graphical user interface for loading data through the data ingestion service of FIG. 1, according to one embodiment.

FIG. 5 illustrates a wireframe of an example graphical user interface for managing tags through the tags service of FIG. 1, according to one embodiment.

FIG. 6 is a schematic diagram illustrating interactions between data models and the system of FIG. 1.

FIG. 7 is a schematic diagram illustrating how various data models can coexist under one platform.

### DETAILED DESCRIPTION

The present disclosure describes a data ingestion platform that supports input of a large number of different dynamic data types. The system is designed for processing and making use of large volumes of data, regardless of the data model that is eventually used to store the data. The system is compatible with ingesting data for structured systems, such as SQL databases and also unstructured systems, such as NoSQL systems. In one embodiment, the system separates, analyzes and tags each piece of data with a unique identifier as it is being ingested. This removes the need to define a prior database or other schema or modelling methods for the data before performing the ingestion process.

Embodiments of the system may be used in areas such as data processing, data storage, analytics, big data, etc. In one embodiment, the system can be applied to medical data analysis and input of the myriad of medical records. Such records may include a plurality of different data types, such as text, document, graphic, image, video and audio files on a particular patient. In addition, data output from medical systems such as EKG, EEG, MRI and other medical sensing and measuring devices may be stored in a medical record being input into the system. The system can include methods of ingesting data, creating tags and relations for that data, and using the processed information for lookup and retrieval.

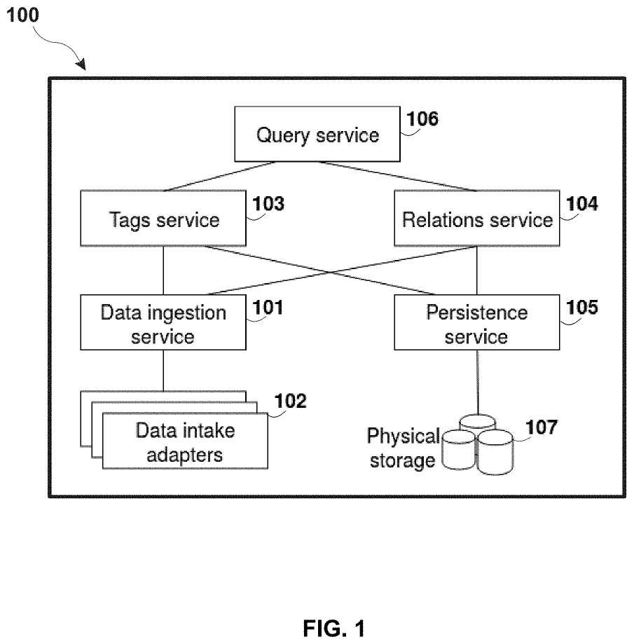

FIG. 1 illustrates an overview of a data ingestion and processing system 100. In some embodiments, the system 100 can include a data ingestion service 101, data intake adapters 102, a tagging service 103, a relations service 104, a persistence service 105, a query service 106, and a physical storage component 107. It should be realized that these services may be run on one or more processors which are programmed or configured to manage each service within the system.

The data ingestion service 101 and the data intake adapters 102 are responsible for data loading. The data ingestion service 101 can manage intake workflows so that data can be discovered, ingested, and processed by the system 100. The data ingestion service 101 can be in communication with the persistence service 105, which provides access to data stored in the physical storage component 107 Likewise, the data intake adapters 102 can discover and access information sources, such as medical data sources, to perform parsing of raw data, and returning outputs to the system in an iterable format in which the raw data is divided into elements, such as rows, that can be processed by the system. The outputs can be items in a data processing queue (messages). The messages generated by the data intake adapters 102 can be passed to a data loading service which routes the messages to other components of the system 100.

The data intake adapters 102 can be implemented as a data producer in the data pipeline architecture, generating messages into downstream services. In some embodiments, the data ingestion service 101 and data intake adapters 102 are configured such that the ingestion of each data element is an independent transaction that symbolizes a single unit of work and is treated coherently and reliably, being separated from other transactions. By treating the ingestion of each data element as an independent transaction, the system 100 can provide isolation between applications. The process of ingesting data elements as independent transaction depends on the data source. For instance, in the case of Health Level-7 (HL7) streams, each HL7 message can be treated as a separate transaction. Whereas, in the case of unstructured flat files, the entire dataset (all files constituting a dataset) can be treated as a single transaction. The system 100 can also access data remotely, separately, and reliably to correct failures, which may constitute data intake or uptake stoppage or incompletion.

The data ingestion service 101 can use adapter patterns to handle various data models. As such, the system 100 can implement specialized data intake components that support required data structures, physical formats, or loading methods (e.g. file system access, database connections, web service requests, etc.). In some embodiments, the system 100 includes a tabular model adapter that can process data that has been organized in row and column structures. In some embodiments, the data ingestion service 101 and/or the data intake adapters 102 can provide translations of various types of data, for instance JavaScript Object Notation (JSON) data or HL7 medical data formats, depending on the requirements for a specific use case. As discussed in greater detail below, to ensure flexibility and extensibility, the system 100 can enable users to specify the intake and tagging processes. For instance, the system 100 can include tools for creating specifications of the transformations and managing execution of data processing pipelines. This can be accomplished, for instance, through a BigSense server to write transformations using python programs that take data as input, apply required logic, and return output.

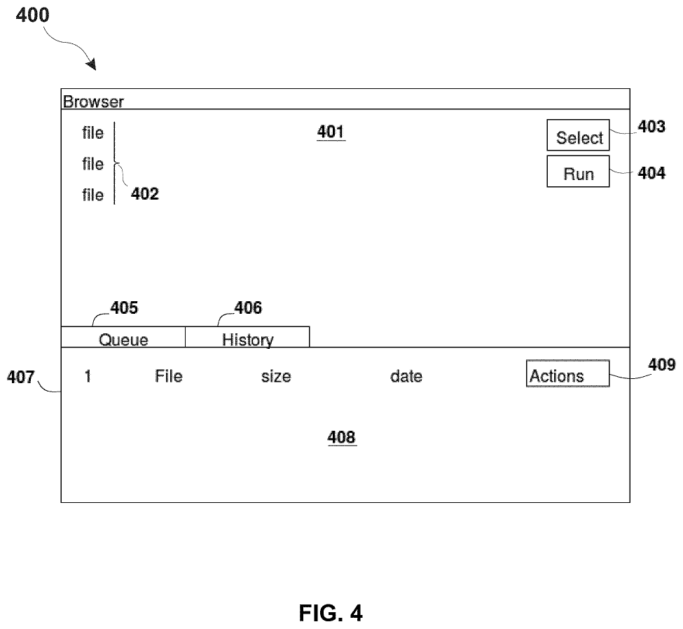

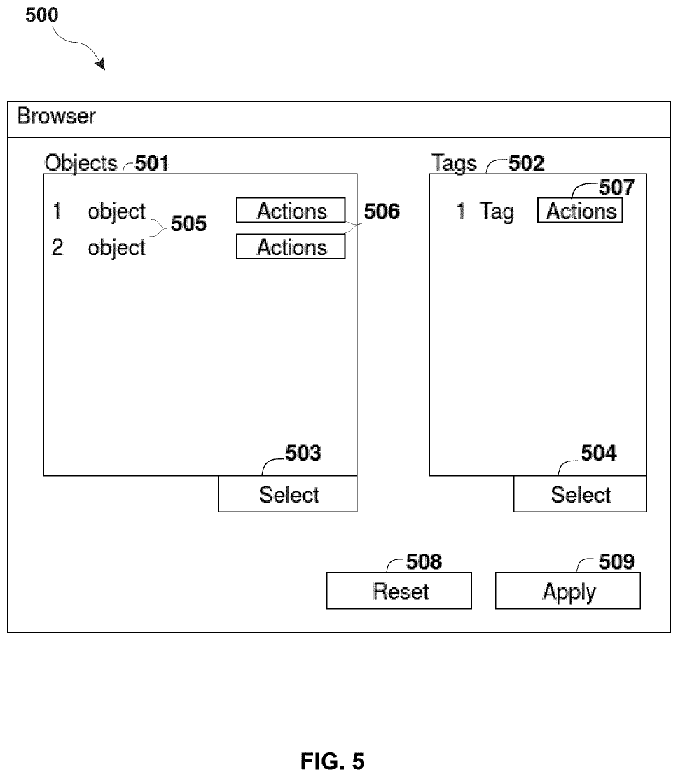

In some embodiments, the system 100 can provide graphical user interfaces for working with these specifications and transformations (see FIGS. 4 and 5). In some embodiments, the system 100 can include an Application Programming Interface (API) that can provide functionalities for programmable interactions with the data ingestion service 101 and/or the data intake adapters 102. In some embodiments, the system 100 can provide programming libraries and web services (e.g., implemented as REST API) for interacting with the data ingestion component resources (i.e., the data ingestion service 101 and the data intake adapters 102).

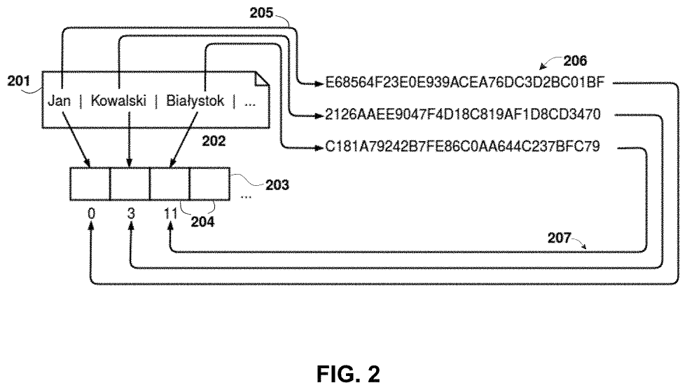

FIG. 2 illustrates a process 200 of data being ingested, processed and represented by the system 100. In some embodiments, while ingesting the data from a data model, the data intake adapters 102 parse raw data into individualized data elements 201 (e.g., dates, names, addresses, etc.). The parsed data elements 201 can include links that tie the data elements back to the original data model from which they were imported. For instance, a data ingestion log may be created where one entry corresponds to a single data source. Then linking back to the data source involves creating a relation to this element in the data ingestion log. As shown, the raw data 201 includes three elements, Jan, Kowalski, and Bialystok within a single file. The data elements 201 can each be recorded 202 in a specific and distinct location in a memory 203. As a result, each data element 201 can have a respective memory address 204 from which the data elements 201 can be accessed. As shown, the element Jan is stored at memory address 0, the element Kowalski is stored at memory address 3, and the element Bialystok is stored at the memory address 11. In some embodiments, the system 100 stores data values in memory pools instead of at particular addresses. In the case of string values, the system 100 may maintain only unique items in the memory 203. In other words, identical string representations may reference only one memory address 204. Such a mechanism helps to reduce memory resources that are required for handling the data. In some embodiments, the memory addresses 204 can be interpreted as object identifiers. Numerical values can be automatically translated to identifiers, such that the value becomes an identifier of the data elements. The data elements 201 stored in the memory 203 can be accessed directly from the memory 203 by pulling the data elements 201 from their memory address 204. In some embodiments, the data can be accessed directly from the memory 203 using a computer programming language, such as Java, C++, Python, etc. This removes the need for a limiting, model-specific interface to access and work with the data.

Further, in some embodiments, unique string representations 206 can be associated with the data elements. The system 100 can apply a hash function to generate a shorter, fixed sized representation of variable length text data elements. Non-limiting examples of hashing algorithms that can be used include: DJB2, DJB2a, FNV-1, FNV-1a, SDBM, CRC32, Murmur2, and SuperFastHash. The string representations 206 can also be mapped 207 to the specific memory addresses 204 (identifiers) that contain the data being accessed. The system 100 can use hash tree structures to represent mappings between the hashed values and the memory addresses 204. In some embodiments, the system 100 uses scapegoat tree data structures to implement the mapping of the string representations 206. Other data structures that support effective lookup and updates can also be used for data representation. Scapegoat trees, which can be used for data representation, provide O(log n) worst case search time and optimal amortized update costs.

By using a hash mechanism, for instance a hash array mapped trie, a unique identifier can be applied to each data stored in a specific memory address. This allows the ingestion system to input data, parse the data into specific portions stored in a unique memory address, and then tag the data by creating a hash that specifically points to that memory address.

In some embodiments, the system 100 includes a relations service 104. The relations service can be an automatic and/or manual mechanism for creating data relations. Thus, in addition to tagging, the system 100 can also enhance loaded data with data relations using the relations service 104. The relations can represent connections among the data elements and information about a source or a destination. The relations can also have a name and vector of relation values. To create relations, the data can be organized in a column structure. In some embodiments, the relations may be assigned to complex data objects, such as rows or tables.

The relations service 104 can examine data and find matches based on similarities. The relations service 104 can assess similarities using statistical methods. The values of similarity metrics can be included in a relation values element of a relation object. A data element, such as a column, may belong to one or more relations, or it may belong to none. In some embodiments, the relations service 104 can be implemented on a graphical user interface for working with data relations. The relations interface can provide features for defining relations, reviewing, updating, and tracking changes. In some embodiments, the system can leverage feedback received from users to ease future searches. The relations service 104 can include an API exposing method for interacting with the data relations. The API may be implemented as a shared library or a web service.

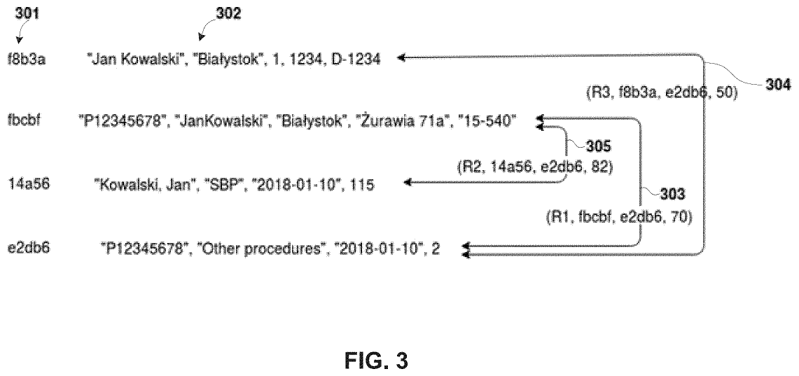

FIG. 3 illustrates an example embodiment of relations that can be derived using the relations service 104 and the techniques described herein. In a non-limiting example, data objects 302 can include healthcare information, such as patient identifying information, medical history, medical codes, etc. The data codes 302 be vectors of values representing rows of data (observations). In some embodiments, based on the similarities, the relations service 104 can determine that the objects 302 may contain information about the same patient. The relations service 104 can generate relations 303, 304, 305 and use data object identifiers 301 (such as those interpreted from the memory addresses 204) to reference the data elements. The relations service 104 allows users to quickly understand and make use of the data by creating a network of connected objects. Relations help to deal with data that is provided in multiple formats, encodings, or labeled by different rule sets.

Automatic tagging and relations mechanisms can help to minimize the need of upfront data preparations, so that users can avoid laborious tasks such as exploration, modeling, cleaning, or reconciliation with other sources. Furthermore, the automation of the process mitigates the risk of human error or bias resulting in more reliable and valuable data available for analysis.

In some embodiments, the tags service 103 and relations service 104 can be applied to data in the system 100 after the ingestion process has been completed. The system 100 may run the tags service 103 and the relations service 104 on existing data to update or provide new data based on newly obtained information. For example, the system 100 may store clinical data with previously generated tags and relations.

Once new reference data is available, such as new versions of medical coding dictionaries, the tags service 103 can execute the tagging process and use the new data to add new tags representing new versions of medical codes to the existing data. Furthermore, the system 100 can leverage this mechanism to improve data quality over time. The system 100 can execute the tagging process and apply specialized transformations to handle missing or corrupted data and information represented in multiple formats or versions. Each data element can be tagged multiple times with different tags.

In some embodiments, the system 100 includes a data persistence service 105. The data persistence service 105 can enable the data to survive after the data ingestion has ended. In other words, the data store is written to non-volatile storage. The data persistence service 105 can provide access to data stored in the data storage component 107 and can act as an interface to the physical storage component 107. The physical storage component 107 can be a shared elastic memory system or can be implemented as a distributed storage and processing system. The physical storage component 107 can be capable of persisting and retrieving data and can expose a service or API for communication with other system elements. In some embodiments, the data storage component 107 can be available as an on premise resource or as a private or public cloud service.

The system 100 further can include a query service 106 that provides methods for searching and retrieving information from the system 100. Clients can specify query criteria and send requests to the query service 106. The query service 106 can process queries and search the internal data structures for elements that satisfy specified conditions. Elements identified by the query service 106 are then returned to the client. In some embodiments, clients may define queries using keywords. In some embodiments, the query service 106 can handle requests formulated in natural language. A graphical user interface can be provided as a convenient method for generating queries through the query service 106. In some embodiments, the system 100 may include an API exposing method for creating queries and sending requests. The API can be implemented as a web service.

The query service 106 can receive user requests as input, parse the requests, validate the requests, and prepare a query plan based on user specifications. The query service 106 can apply optimizations or use cached data to provide efficient lookup and retrieval. In some embodiments, the query service 106 internally leverages tagged data to perform searches. That is, the structures used in the system 100 to represent tagged data through the tags service 103, can support efficient lookup via the query service 106. Furthermore, the system 100 can support set operations on tags (e.g., union, intersection, difference). This provides powerful searching and retrieval capabilities that are important for analytics or visualization applications.

The query service 106 can further be configured to include relations information in lookup. The user may leverage relations generated by the relations service 104 to join data sets and integrate data sources. Furthermore, the relations data can also be used in exploration by providing information about similarities between data elements. The relations information can also be leveraged in data preparations and cleaning stages of data analysis by suggesting similar or related data elements that can be then used for data reconciliation, validation, or specialized methods of handling missing or incomplete data. In some embodiments, the persistence service 105 can be used by the query service 106 as data source, and can leverage the information that is generated by the tagging service 103 and the relations service 104 in order to provide fast access to data and querying capabilities.

FIG. 4 shows an example wireframe of a graphical user interface 400 for loading data through the data ingestion service 101. The interface 400 can be available to a user as an application accessible with a web browser. The interface 400 can be divided into two areas: selection and staging area 401 and jobs area 408. The staging area 401 can display a list 402 of data sources that were selected by the user. The staging area can include buttons for opening a selection wizard (select button 403) and job execution (run button 404). The jobs area 408 can provide information about a job queue 405 and history of job executions 406. A job can be displayed in a list 407, with details such as file name, data size, start date, job status, etc. The job can include an actions button 409 that provides a list of available actions that can be applied to the job including stopping, repeating, and reviewing details of exporting information to files.

FIG. 5 illustrates a wireframe of a graphical user interface 500 for managing tags. The tags service 103 is configured to assign information to the data elements. The tags service can include an interface 500 that can be accessible with a web browser. In some embodiments, the interface 500 includes an objects section 501. The objects section 501 can provide information about objects 505 in the system 100 and includes features for lookup, filtering, and selection 503. The actions buttons 506 can provide access to available options for the objects 505 in the objects section 501. The interface 500 can also include a tags sections 502 that provides information about tags together with features enabling review, selection, creation, and updates of tags. In some embodiments, tags can be assigned manually based on user specifications. Tagging options can be available through the actions button 507. The user can rollback changes made in the interface 500 using a reset button 508 or commit to the changes using an apply button 509.

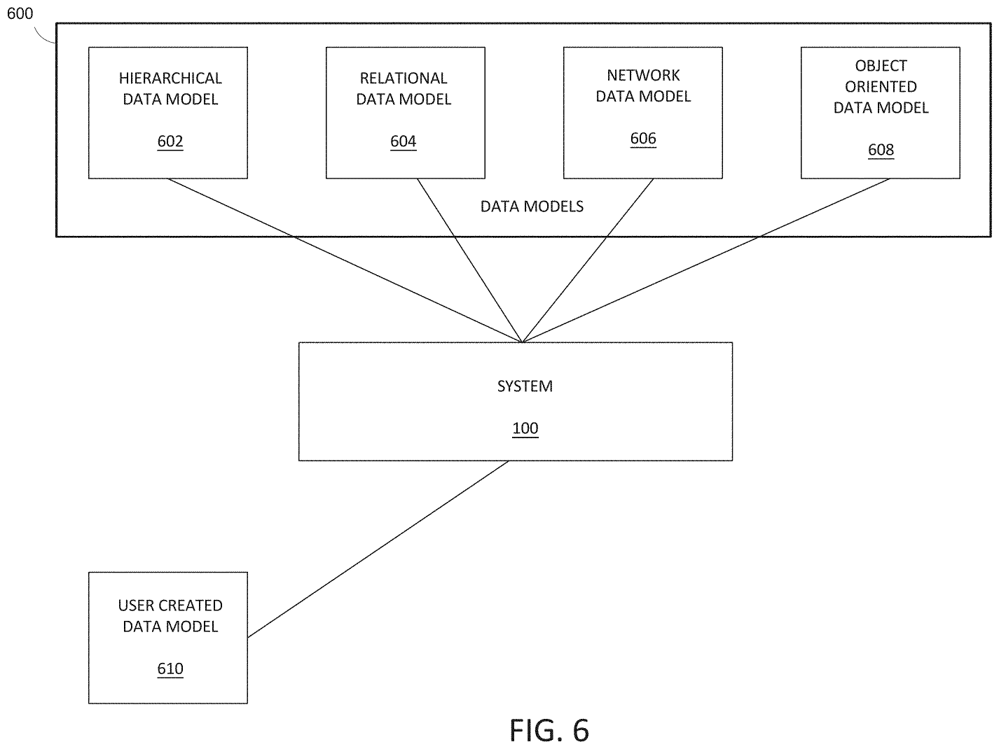

FIG. 6 illustrates the system 100 operating with a variety of different data models 600. The data models 600 can be any models including a hierarchical data model 602, a relational data model 604, a network data model 606, an object-oriented data model 608, or other data models. For example, other data models may include, entity relationship, document, entity-attribute-value, start schema, or other similar data models. The data from the data models is imported into the system 100, where it can then be accessed by any other data model or accessed directly using a programming language. As described above with reference to FIG. 2, the data intake adapters can parse data from any of the data models 600 into individualized data elements. The system 100 can apply hash functions to the data elements to obtain unique string representations. The individualized data elements can be recorded into memory and linked back to the original data model from which it was imported. As a result, each data element can have a distinct memory address from which the data elements are accessed, for instance by a user created data model 610.

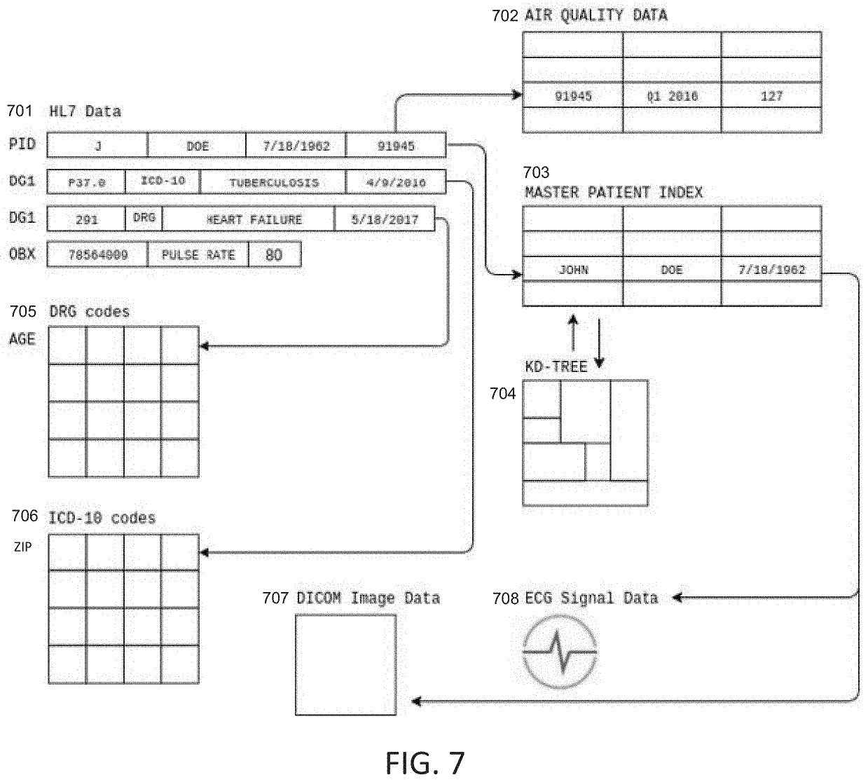

FIG. 7 demonstrates how various data models can coexist under one platform. The example of FIG. 7 is in the context of medical data, however, it will be understood that the same techniques could be applied to a wide variety of fields. Data source 701 can be an HL7 message data model where each message corresponds to health event segments. In the example of FIG. 7, the health event segments include a patient identification segment (PID), diagnosis segments (DG1), and an observation/result segment (OBX). The segments can be further divided into fields and sub-fields (e.g. family name, date of birth, diagnosis, etc.). The information in each of the fields of the segments can further be stored in tabular data models. For instance, a first tabular data model 702 can store data related to air quality indexes as a table which can be further divided into rows and columns. A second tabular data model 703 can be configured to store lists of unique patient information. A KD-Tree data structure 704 can organize information in the master patient index (second tabular data model 703) to facilitate searches for similar information. The example of FIG. 7 can further include a dense data matrix 705 to store conditional probabilities of specific diagnosis related groups (by DRG code) according to age group. A sparse data matrix 706 can store conditional probabilities of specific conditions (by ICD-10 code) according to ZIP codes. The Conditional probabilities can provide the probability of a specific event when specific conditions are met, based, for example on historical data spanning certain periods. For example, the probability of diagnosing specific medical conditions (e.g., asthma or food allergy) may be estimated from specific geographical areas defined by ZIP code. Likewise, the probability of diagnosis related group (e.g. AMI or COPD) can be estimated based on historical data corpus, depending on which age group patient falls into. In some embodiments, imaging data 707 tied to the master patient index can be in DICOM format, and a time series data model 708, also tied to the master patient index, can store electrocardiography (ECG) information. Thus, individual data elements (e.g., fields and cells) or objects (e.g. table, matrix, message, image, and time series) can be interconnected, thereby forming a directed acyclic graph which is a higher order data model.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

The disclosed processes may begin in response to an event, such as on a predetermined or dynamically determined schedule, on demand when initiated by a user or system administer, or in response to some other event. When the process is initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware based computer processor of the computing device. In some embodiments, the process or portions thereof may be implemented on multiple computing devices and/or multiple processors, serially or in parallel.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. An electronic system for ingesting and processing data from multiple sources, the system comprising:
a data ingestion service configured to parse the data into data elements and to ingest each data element as an independent transaction;
a tagging service configured to assign information to each data element;
a relations service configured to identify relations between the data elements;
a query service configured to receive a query request, and in response, access, lookup, and retrieve data that matches the request; and
a physical storage component configured to store the data elements and tagging information,
wherein each data element is assigned to a memory address in the physical storage component and is hashed to obtain a unique string representation for each data element, the string representation being mapped to the memory address.

2. The system of claim 1, wherein the data elements are capable of being accessed directly from the physical storage component.

3. The system of claim 1, wherein the data elements are linked to their data source.

4. The system of claim 1, wherein identical string representations reference a single memory address.

5. The system of claim 1, wherein the data ingestion service comprises one or more data intake adapters configured to discover and access information sources, perform the parsing of data, and return outputs in an iterable format.

6. The system of claim 1, wherein the tagging service and/or relations service are configured to be applied to existing data elements in the system in order to update or provide new data based on newly obtained information.

7. The system of claim 1, wherein the query service is configured to internally leverage the information assigned to each data element by the tagging service when performing searches.

8. The system of claim 1 further comprising a tagging graphical user interface configured to allow a user to manage the tagging service via a web browser.

9. The system of claim 1 further comprising a relations graphical user interface configured to allow a user to manage the data relations via a web browser.

10. The system of claim 1 further comprising a query graphical user interface configured to allow a user to manage queries via a web browser.

11. The system of claim 1, wherein the relations service uses data object identifiers to reference the data elements.

12. The system of claim 1, wherein the query service is configured to internally leverage relations information when performing searches.

13. The system of claim 1, wherein the physical storage component is a non-volatile storage.

14. The system of claim 1, wherein the physical storage component is a shared elastic memory system.

15. The system of claim 1, wherein the data ingestion service is configured to implement adapter patterns to handle the multiple types of data.

16. An electronic method running on a processor for ingesting and processing data from multiple sources, the method comprising:
loading the data for discovery, ingestion, and processing; and
parsing the data into data elements, each data element being ingested as an independent transaction;
wherein each data element is assigned to a memory address in the physical storage component and is hashed to obtain a unique string representation for each data element, the string representation being mapped to the memory address.
